(19) United States
(12) Patent Application Publication
(10) Pub. No.: US 2008/0020649 A1
(43) Pub. Date: Jan. 24, 2008

(54) ELECTRICAL CONNECTOR AND ASSEMBLY

(75) Inventors: Richard J. Scherer, Austin, TX (US); Jess A. Mann, Austin, TX (US); Jerome P. Dattilo, Cedar Park, TX (US); Michael L. Black, Cedar Park, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/775,774

(22) Filed: Jul. 10, 2007

Related U.S. Application Data
(60) Provisional application No. 60/820,193, filed on Jul. 24, 2006.

(51) Int. Cl. H01R 33/90

(52) U.S. Cl. 439/639; 439/626; 439/649

(57) ABSTRACT

An electrical connector has a housing that includes a mating end defining a first connector relief segment opposite a second connector relief segment and a first connector projection segment opposite a second connector projection segment. At least one male contact extends from a face of the first connector relief segment and at least one male contact extends from a face of the second connector relief segment. At least one female contact is formed in a face of the first connector projection segment and at least one female contact is formed in a face of the second connector projection segment. In this regard, the mating end is configured to align and mate with a mating end of a second substantially identical electrical connector.

### REFERENCE TO CROSS-RELATED APPLICATIONS

The present application claims priority to U.S. Provisional Patent Application 60/820,193, filed Jul. 24, 2006.

### BACKGROUND

Electrical connectors are used throughout the telecommunication and electronics industries, and can be employed in a wide variety of applications. Common and useful electrical connector applications include interconnecting discrete electrical wires, interconnecting circuits or printed circuit boards, or interconnecting two or more parallel or serial electrical units in a telecommunications system. Electrical connectors are also used in a wide variety of environments, such as between indoor and outdoor environments when connecting an end user with a service provider, for instance.

In this regard, high craft skill is often required when connecting between end users and service providers. For example, in many applications interconnecting electrical connectors necessitates skilled “hands-on” wiring of multi-wire devices, which can be complex, and thus require a higher technician skill level with an associated higher cost. In addition, interconnecting electrical connectors can involve connecting one type of connector, such as a plug that is connected to a plain old telephone service (POTS) device in a home, to a different type or style of connector, such as a plug used by a service provider. In this regard, correctly matching plugs can be time consuming for technicians, and thus costly for the service provider.

The present invention is directed to providing simple, inexpensive and effective electrical connectors useful in, for example, the telecommunication industry, and in other applications and industries that desire improved electrical connectors.

### SUMMARY

One aspect of the present invention provides an electrical connector having a housing and a plurality of contacts. The housing includes a mating end defining a first connector relief segment opposite a second connector relief segment and a first connector projection segment opposite a second connector projection segment. At least one male contact extends from a face of the first connector relief segment and at least one male contact extends from a face of the second connector relief segment. At least one female contact is formed in a face of the first connector projection segment and at least one female contact is formed in a face of the second connector projection segment. In this regard, the mating end is configured to align and mate with a mating end of a second substantially identical electrical connector.

Another aspect of the present invention provides a backup power system. The system includes a battery backup unit, and a network unit electrically communicating with the battery backup unit via at least one pair of coupled hermaphroditic electrical connectors. Each of the hermaphroditic electrical connectors includes a mating end that defines a first connector relief segment opposite a second connector relief segment and a first connector projection segment opposite a second connector projection segment. At least one male contact extends from a face of the first connector relief segment and a single male contact extends from a face of the second connector relief segment. At least one female contact is formed in a face of the first connector projection segment and a single female contact is formed in a face of the second connector projection segment. In this regard, the first connector projection segment of a first hermaphroditic electrical connector in the pair couples into a respective first connector relief segment of a second hermaphroditic electrical connector in the pair such that the at least one female contact formed in the face of the first connector projection segment aligns with and receives the at least one male contact extending from the first connector relief segment, and the second connector projection segment of the first hermaphroditic electrical connector couples into a respective second connector relief segment of the second hermaphroditic electrical connector such that the single female contact aligns with and receives the single male contact.

Another aspect of the present invention provides a coupler coupled between a battery backup unit and a network unit. The coupler includes a first hermaphroditic electrical connector, a second hermaphroditic electrical connector, and a plurality of electrical conductors coupling and extending between the first hermaphroditic electrical connector and the second hermaphroditic electrical connector. Each hermaphroditic electrical connector includes a mating end that defines a first connector relief segment opposite a second connector relief segment and a first connector projection segment opposite a second connector projection segment. At least one male contact extends from a face of the first connector relief segment and a single male contact extends from a face of the second connector relief segment. At least one female contact is formed in a face of the first connector projection segment and a single female contact is formed in a face of the second connector projection segment. In this regard, the first hermaphroditic electrical connector is plugged into a corresponding hermaphroditic electrical connector that is electrically coupled to one of the battery backup unit or the network unit, and the second hermaphroditic electrical connector is plugged into a corresponding hermaphroditic electrical connector that is electrically coupled to the other one of the battery backup unit or the network unit.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 illustrates a schematic view of a backup power system according to one embodiment of the present invention.

FIG. 2 illustrates a perspective view of a power and signal connector according to one embodiment of the present invention.

FIG. 3 illustrates a perspective view of a power coupler according to one embodiment of the present invention.

FIG. 4A illustrates a perspective view of a mating end of an electrical connector according to one embodiment of the present invention.

FIG. 4B illustrates another perspective view of the electrical connector illustrated in FIG. 4A.

FIG. 4C illustrates a perspective view of a mating end of another electrical connector according to one embodiment of the present invention.

FIG. 5 illustrates a perspective view of a male contact according to one embodiment of the present invention.

FIG. 6 illustrates a perspective view of a female contact according to one embodiment of the present invention.

FIG. 7 illustrates a perspective of a plurality of male contacts and a plurality of female contacts secured in a housing of an electrical connector according to one embodiment of the present invention.

FIGS. 8A and 8B illustrate an end view of opposing mating ends of a pair of hermaphroditic electrical connectors according to one embodiment of the present invention.

### DETAILED DESCRIPTION

In the following Detailed Description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

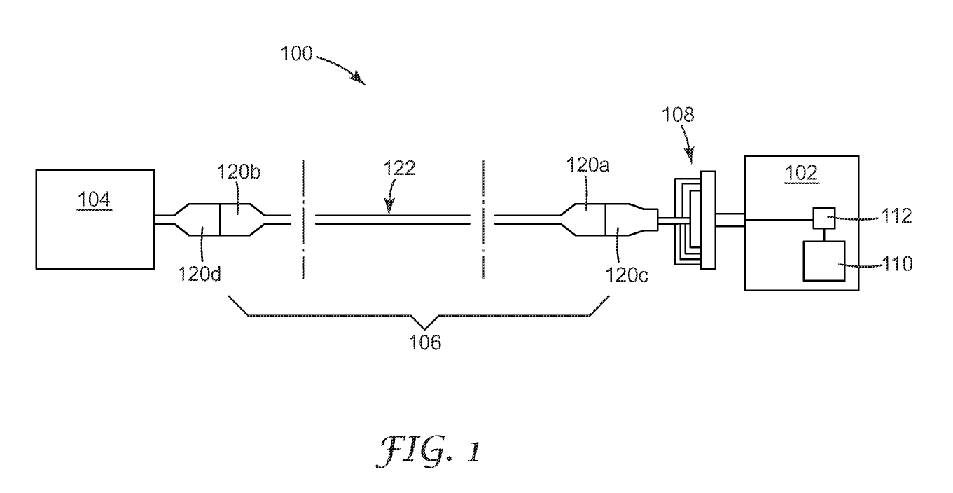

FIG. 1 illustrates a schematic view of an exemplary backup power system 100 according to one embodiment of the present invention. Backup power system 100 includes a battery backup unit 102, a network unit 104, and a coupler 106 electrically connecting battery backup unit 102 to network unit 104. In general terms, battery backup unit 102 is installed in an end user's home or business and can optionally include a connector 108 electrically coupled to and extending from battery backup unit 102. Network unit 104 is generally an electrical unit staged from, or available through, a service provider. In one embodiment, network unit 104 is an optical network unit including high bandwidth broadband services and plain old telephone service (POTS). In this regard, coupler 106 is provided to electrically connect battery backup unit 102 located in a home or office with an exterior network unit 104, thus allowing network unit 104 to monitor, control, and/or otherwise communicate with battery backup unit 102.

With the above in mind, in one embodiment coupler 106 is a power and signal coupler that includes a first hermaphroditic electrical connector 120a, a second hermaphroditic electrical connector 120b, and electrical cable 122 coupling and extending between first and second hermaphroditic electrical connectors 120a, 120b. Cable 122 may have one or more electrical conductors, as will be understood from the description below. Coupler 106 can include multiple segments of similar other such couplers connected in an end-to-end fashion. However, it is to be understood that first hermaphroditic electrical connector 120a is configured to mate with and connect to a substantially identical hermaphroditic electrical connector, such as connector 120c; and second hermaphroditic electrical connector 120b is configured to mate with and connect to a substantially identical hermaphroditic electrical connector, such as connector 120d.

End users, homeowners, and others have become accustomed to the availability of plain old telephone service (POTS) connected into their homes or offices that includes some form of a battery backup unit that allows use and operation of the telephone service in the event of a power interruption. Traditionally, the battery backup unit has been provided as part of the network system, and is customarily located outside of the end user's premises. During electrical storms or other interruptions, the battery backup unit provides temporary battery power that enables the POTS service to remain functional until the mainline electrical services are restored.

Lately, end users, homeowners, and others have shown a strong desire for digital services, such as cable TV, broadband Internet services, and other high-speed and broadband digital products. Digital service providers have been racing to meet the needs of homeowners and others in bringing these services into homes. However, the broadband and other high-speed services are generally connected to and through the electrical service entering the home/office, and are not associated with desired backup power features.

Network units in general, and optical network units in particular, are generally provided by a service provider to stage the run of fiber optic cables into a home or office. These network units, such as network unit 104, provide high bandwidth service in addition to simple POTS service for delivery into the home or office. However, to successfully compete with existing telephone service providers, digital service providers have determined that some form of backup power system is strongly desired by the consumers who have come to expect continued service during power outages. For example, after decades of highly reliable battery backup to POTS, consumers have shown a demand that broadband services wired into their homes or offices also include some form of backup system.

With the above in mind, in one embodiment battery backup unit 102 is provided within the end user's dwelling to provide reserve/backup power for the broadband and other high-speed services brought to the dwelling. In one embodiment, battery backup unit 102 is wired into the dwelling and includes a battery 110, an electronic control unit 112, and a connector 108 that is configured to couple to coupler 106. The connection of coupler 106 between network unit 104 and battery backup unit 102 electrically connects the two units and enables a battery backed plug-and-play capability that is staged by the service provider to the dwelling. To this end, coupler 106 is simple to use and quick to install. By interfacing multiple couplers 106 end-to-end, or serially, embodiments of the present invention permit adding a desired cable length by simply plugging one coupler 106 to another coupler 106 in connecting between battery backup unit 102 and network unit 104.

FIG. 2 illustrates a perspective view of power and signal connector 108 according to one embodiment of the present invention. Power and signal connector 108 includes a junction box 130, and an array 132 of wires extending through junction box 130 that terminate at connector 120c. Junction box 130 is configured to receive electrical wires/cables extending from battery backup unit 102 (FIG. 1). In this regard, array 132 of wires includes multiple power and signal cables. In one embodiment, array 132 includes two power cables 140a, 140b, and five signal cables 150, 152, 154, 156, 158. In other embodiments, array 132 includes more than seven wires; alternatively, array 132 can include fewer than seven wires. Additionally, the number of power and signal wires may vary. In any regard, array 132 of wires extend from battery backup unit 102 and is electrically coupled to connector 120c.

Connector 120c is similar to the other electrical connectors, 120a, 120b, and 120d (FIG. 1). In this regard, each of the electrical connectors, 120a, 120b, 120c, and 120d includes a housing 160 that defines a mating end 162. Mating end 162 is configured to align and mate with a mating end of a second substantially identical electrical connector. For example, electrical connector 120c is configured to align and mate with electrical connector 120a, as best illustrated in FIG. 1.

In general, each of the electrical connectors 120a, 120b, 120c, and 120d are hermaphroditic electrical connectors that are configured to mate and align with a second, separate substantially identical such hermaphroditic electrical connector. With this in mind, the following figures will refer to the similar, shared structure of the substantially identical hermaphroditic electrical connectors 120.

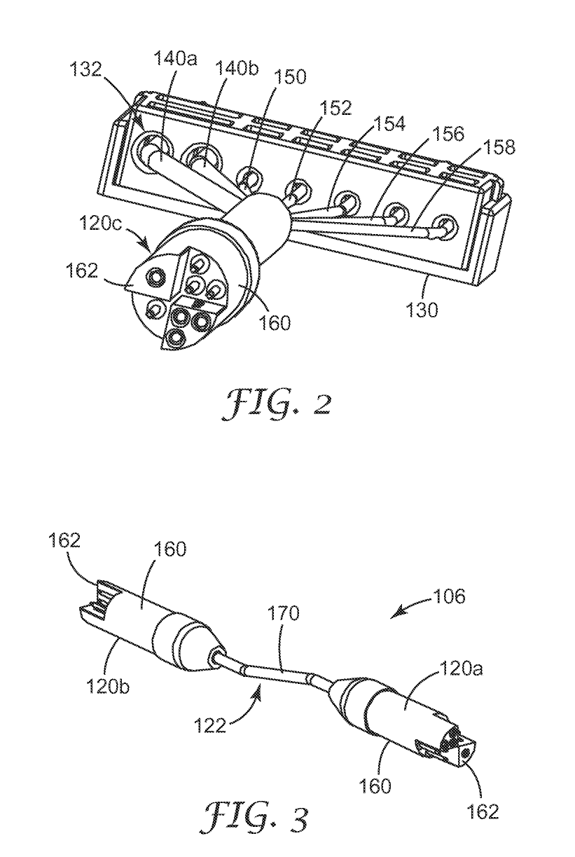

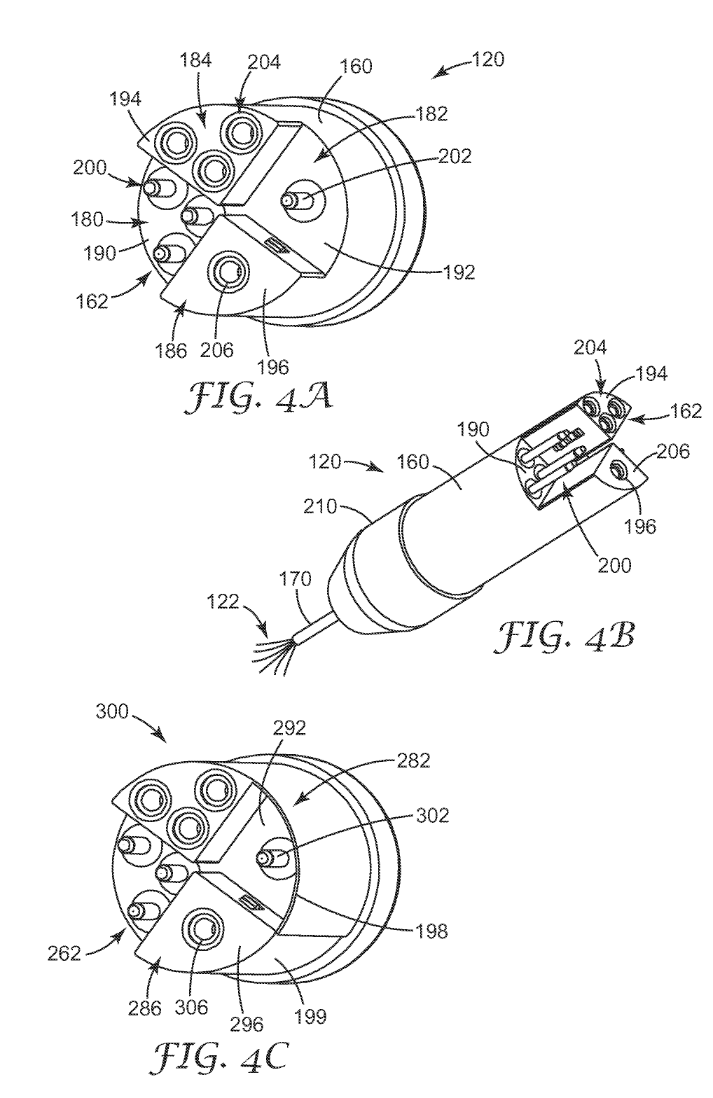

FIG. 3 illustrates a perspective view of coupler 106 according to one embodiment of the present invention. Coupler 106 includes first hermaphroditic electrical connector 120a, second hermaphroditic electrical connector 120b, and an electrical cable 122 including a plurality of conductors (best illustrated in FIG. 4B) coupled and extending between first and second hermaphroditic electrical connectors 120a, 120b. In one embodiment, the plurality of conductors of cable 122 is maintained within a casing 170.

As shown and described above, each of the hermaphroditic electrical connectors 120a and 120b includes housing 160 and mating end 162. During use, a service provider would employ one or more of the couplers 106 in electrically connecting battery backup unit 102 to network unit 104 (FIG. 1). For example, mating end 162 is configured to connect to another mating end 162 of another electrical connector 120. In one embodiment, the sequential mating of mating ends 162, and thus the sequential mating of couplers 106, enables the service provider to electrically span distances of about 10-50 feet between battery backup unit 102 to network unit 104.

FIG. 4A illustrates a perspective view of mating end 162 of a generalized electrical connector 120 according to one embodiment of the present invention. Mating end 162 defines a first connector relief segment 180 and an opposing second connector relief 182, and a first connector projection segment 184 opposite a second connector projection segment 186. Each of the segments 180, 182, 184, 186 defines a face. For example, first connector relief segment 180 includes a face 190, second connector relief segment 182 includes a face 192, first connector projection segment 184 includes a face 194, and second connector projection 186 includes a face 196. In this regard, the first and second connector projection segments 184, 186 extend between faces 190, 192 of the respective first and second connector relief segments 180, 182.

In one embodiment, a plurality of male contacts 200 extends from face 190 of first connector relief segment 180, and a male contact 202 extends from face 192 of second connector relief segment 182. In one embodiment, a plurality of female contacts 204 is formed in face 194 of first connector projection segment 184, and a female contact 206 is formed in face 196 of second connector projection segment 186. In general, the plurality of male contacts 200 is configured to mate and align with a plurality of female contacts 204 provided in a second substantially identical electrical connector 120. In a similar manner, male connector 202 is configured to align and mate with female connector 206 provided in a second substantially identical electrical connector.

In this regard, while three male contacts 200 extending from face 190 and three female contacts 204 formed in face 194 are illustrated, it is within the scope of this invention to provide fewer than three such contacts, or more than three such contacts. Likewise, while one male contact 202 extending from face 192 and one female contact 206 formed in face 196 are illustrated, it is within the scope of this invention to provide fewer than one such contact, or more than one such contact.

FIG. 4B illustrates another perspective view of electrical 120 according to one embodiment of the present invention. In one embodiment, housing 160 is injection molded around the plurality of female contacts 204 and female contact 206, and around the plurality of male contacts 200 and male contact 202 (FIG. 4A). In one embodiment, a shell 210 is over-molded over the housing 160 to protect solder connections leading to contacts 200, 202, 204, 206 and to provide strain relief for electrical connector 120. In this regard, plurality of electrical cable 122 enter shell 210 and housing 160 and are soldered, crimped, or otherwise electrically connected in a suitable manner to a respective one of contacts 200, 202, 204, and 206. Casing 170 is provided to conveniently bundle and maintain electrical cable 122.

FIG. 4C illustrates a perspective view of a mating end 262 of another electrical connector 300 according to one embodiment of the present invention. A location of contacts relative to mating end 262 is similar to a location of contacts 200, 202, 204, and 206 relative to mating end 162 of electrical connector 120 (FIG. 4A) described above.

Mating end 262 defines a second connector relief segment 282 that includes a protective sleeve 198 extending from face 292. Protective sleeve 198 is electrically insulating and provided to prevent undesired contact with male contact 302 during disassembly of two mated connectors 300, for example. In this regard, face 296 of segment 286 includes a relief portion 199 that is configured to receive sleeve 198 when mating with a substantially identical connector 300, such that connector 300 is of a hermaphroditic style. In one embodiment, a thickness of sleeve 198 is between about 0.0001 inch to 0.020 inch, and relief portion 199 of segment 286 is relieved an amount sufficient to enable segment 286 to receive sleeve 198 when two connectors 300 are mated. It is to be understood that the thickness of sleeve 198 is selected to be suited to a size of the connector 300, such that sleeve 198 is relatively thicker for a male contact 302 having a higher amperage rating, for example.

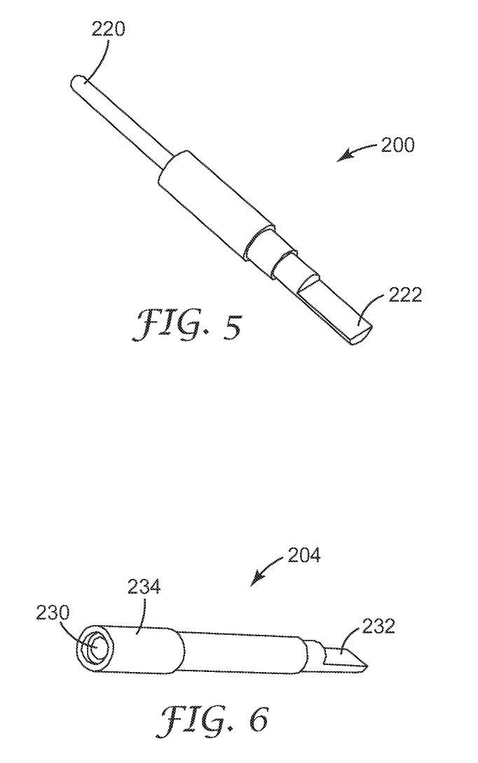

FIG. 5 illustrates a perspective view of one male contact 200 according to one embodiment of the present invention. Male contact 200 includes a contact area 220 and a solder pad 222. In one embodiment, contact area 220 is a rounded pin, and solder pad 222 is formed opposite of contact area 220 and defines a pad area useful for soldering wires for electrical contact with male contact 200. In one embodiment, male contact 202 (FIG. 4A) is substantially identical to male contact 200.

FIG. 6 illustrates a perspective view of one female contact 204 according to one embodiment of the present invention. Female contact 204 includes a contact area 230, a solder pad 232 opposite of contact area 230, and a stress relaxation restrictor 234 formed over a portion of contact area 230. In one embodiment, contact area 230 is formed as a recess within female contact 204, and stress relaxation restrictor 234 is provided to reinforce female contact 204 during repeated electrical connections with a male contact, for example male contact 200 (FIG. 5). In one embodiment, female contact 206 (FIG. 4B) is substantially identical to female contact 204.

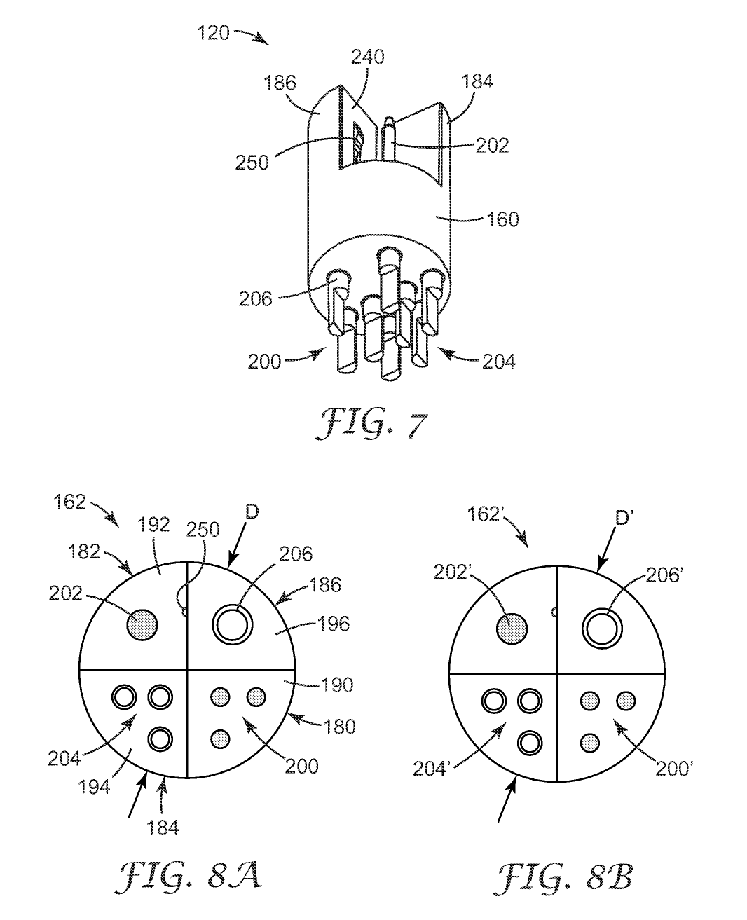

FIG. 7 illustrates a perspective view showing a back side of electrical connector 120 according to one embodiment of the present invention. Electrical connector 120 includes contacts 200, 202, 204, and 206 pressed into housing 160. In this regard, FIG. 7 illustrates connector 120 prior to wiring of contacts 200-206 and prior to over molding housing 160 with shell 210 (FIG. 4B).

As oriented in FIG. 7, first connector projection segment 184 is on a right hand side, and second connector projection segment 186 is on a left hand side of male contact 202. In one embodiment, second connector projection segment 186 includes a first side wall 240 opposite a second sidewall (not visible) and a friction latch 250 is formed on sidewall 240. In one embodiment, friction latch 250 includes an interference bump that is provided to tune and provide a holding force for holding connector 120 when mated to a second substantially identical electrical connector 120.

Friction latch 250 can include a bump, a projection, or other suitable variation in the surface of one or more sidewalls of the connector 120. For example, in one embodiment friction latch 250 is a raised wavy pattern, such as a wavy “S” pattern, formed or otherwise molded into sidewall 240. Selectively forming or molding friction latch 250 to project a desired distance off of the surface of sidewall 240 enables tuning of friction latch 250, such that friction latch 250 is an adjustable friction latch. In general, friction latches 250 that project more prominently off of the surface of the sidewall 240 necessitate a greater force when engaging and separating two mated friction latches 250 of two connected hermaphroditic connectors 120. One suitable friction latch 250 is formed to project off of the sidewall 240 between about 0.002 to 0.050 inches, although other suitable dimensions for friction latch are acceptable depending upon a size of the connector 120.

FIG. 8A illustrates an end view of mating end 162. FIG. 8B illustrates a complimentary hermaphroditic mating end 162′ of a second substantially identical hermaphroditic electrical connector that is similar to the electrical connector 120 described above.

With reference to FIG. 8A, first connector relief segment 180 includes male contacts 200 extending from face 190, and second connector relief segment 182 includes male contact 202 extending from face 192. Projecting between the opposing faces 190, 192 are first connector projection segment 184 and a second connector projection segment 186. Female connectors 204 are formed in face 194 of first connector projection segment 184, and a female connector 206 is formed in face 196 of second connector projection segment 186.

In one embodiment, mating end 162 defines a perimeter that is substantially circular (i.e., round) having a diameter D. In one embodiment, diameter D ranges between about 0.25 inch to about 1.25 inch, and preferably diameter D is about ⅜ inch. To this end, mating end 162 is relatively narrow, such that during installation a technician is able to fish or otherwise thread coupler 106 (FIG. 3), for example, easily through entrance holes bored through walls or ceilings.

FIG. 8B illustrates an end view of a complimentary hermaphroditic mating end 162′ disposed alongside mating end 162 (FIG. 8A). The male contacts 200′ are configured to align with and be inserted into the female contacts 204, and the male contact 202′ is configured to mate with and align into female contact 206. In a similar manner, female contacts 204′ are configured to receive male contacts 200, and female contact 206′ is configured to receive male contact 202.

In one embodiment, mating end 162′ defines a perimeter that is substantially circular (i.e., round) having a diameter D′. In one embodiment, diameter D′ ranges between about 0.25 inch to about 1.25 inch, and preferably diameter D′ is about ⅜ inch. In this regard, diameter D is similar to diameter D′ and mating end 162 is similar in conformation to mating end 162′.

Referring to mating ends 162 and 162′ of FIGS. 8A and 8B, respectively, when mated, male contacts 200 connect into female contacts 204′, male contact 202 connects into female contact 206′, female contacts 204 receive male contacts 200′ and female contact 206 receives male contact 202′. In general, male contacts 202, 202′ are, for example, 3 Amp power contacts, and male contacts 200, 200′ carry signal/control signals for communication with, for example, battery 110 and controller 112 in battery backup unit 102. In this regard, and with reference to FIG. 1, control unit 112 within battery backup unit 102 reads and receives signals from network unit 104 via male contacts 200, 200′ to monitor and control battery 110 discharge, rate of battery 110 discharge, battery 110 recharge, rate of battery 110 recharge, etc. between battery backup unit 102 and network unit 104. It is to be understood that male contacts 202, 202′ can be less than 3 Amp power contacts, or in other embodiments, male contacts 202, 202′ can be more than 3 Amp power contacts. In this regard, male contacts 202, 202′ are suitably sized depending upon the power capacity of the connector 120.

In a typical network system connection, and with reference to FIG. 1, a battery backup unit is provided in a dwelling and often includes a wired power and signal connection of some sort. When a homeowner or customer desires to have cable, Internet, or other broadband Internet services brought into their home or dwelling, a service provider connects to the power and signal wires, thereby accessing the battery backup unit. In a typical known installation, signal and power wires extending from the battery backup unit would be screwed down or otherwise terminated to a connector that extends from the battery backup unit. The screw-down termination of wires is time consuming, and thus expensive, and necessitate a higher technician skill level. Absent a sufficient technician skill level, screw-down termination of wires is error-prone. Additional lines and contacts would then be connected between the connector associated with the battery backup unit and the network unit, which might entail additional time and effort by a technician.

In contrast, embodiments of the present invention provide electrical connection between network unit 104 and battery backup unit 102 by plugging mated pairs of hermaphroditic electrical connectors 120 between battery backup unit 102 and network unit 104. Employing the above-described electrical connectors 120 in a backup power system is more time efficient, less costly, and less prone to error as compared to the known screw-down termination of wires.

For example, power and signal connector 108 can include an electrical connector 120c as described above. A coupler 106 that includes an opposing pair of hermaphroditic electrical connectors 120a, 120b is configured to be connected directly to electrical connector 120c, and thus between battery backup unit 102 and network unit 104. In particular, electrical connector 120a is configured to hermaphroditically mate and connect with connector 120c, and in a like manner, electrical connector 120b is configured to mate with electrical connector 120d. By this series of electrical connections of similar hermaphroditic electrical connectors 120, battery backup unit 102 can be electrically connected to network unit 104 through a simple “plug-and-play” methodology.

Although the electrical connectors described above have been described as advantageously connected between a battery backup unit and a network unit in a backup power system, one of skill in the electrical arts will readily understand after reading this specification that the above-described electrical connectors may be beneficially employed when connecting between any two general electrical units/lines in either the telecommunications industry, or in industries other than telecommunications.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An electrical connector comprising:
a housing having a mating end defining a first connector relief segment opposite a second connector relief segment and a first connector projection segment opposite a second connector projection segment;
at least one male contact extending from a face of the first connector relief segment and at least one male contact extending from a face of the second connector relief segment; and
at least one female contact formed in a face of the first connector projection segment and at least one female contact formed in a face of the second connector projection segment;
wherein the mating end is configured to align and mate with a mating end of a second substantially identical electrical connector.

2. The electrical connector of claim 1, wherein the at least one female contact formed in the face of the first connector projection segment comprises a plurality of female contacts sized to receive and configured to align with a plurality of male contacts extending from a face of a first connector relief segment of a separate second electrical connector, and the at least one female contact formed in the face of the second connector projection segment is sized to receive and configured to align with a male contact extending from a face of a second connector relief segment of the separate second electrical connector.

3. The electrical connector of claim 1, wherein the first and second connector projection segments extend between the faces of the first and second connector relief segments.

4. The electrical connector of claim 1, wherein a perimeter of the mating end is substantially round, and further wherein each of the first and second connector projection segments and the first and second connector relief segments are quarter-round.

5. The electrical connector of claim 1, wherein the at least one male contact extending from the face of the first connector relief segment comprises three male contacts extending from the face of the first connector relief segment and the at least one male contact comprises a single male contact extending from the face of the second connector relief segment.

6. The electrical connector of claim 5, wherein the three male contacts are signal contacts and the one male contact is a power contact.

7. The electrical connector of claim 1, wherein each of the first and second connector projection segments define a first sidewall and a second sidewall, at least one of the first and second sidewalls including a friction latch.

8. The electrical connector of claim 1, wherein the mating end comprises a protective sleeve projecting from the face of the second connector relief segment and extending between the first and second connector projection segments.

9. The electrical connector of claim 1, wherein each female contact includes a stress relaxation restrictor sleeve disposed about a periphery of the contact.

10. The electrical connector of claim 1, wherein the housing includes an over molded shell opposite the mating end.

11. A backup power system comprising:
a battery backup unit; and
a network unit electrically communicating with the battery backup unit via at least one pair of coupled hermaphroditic electrical connectors, each of the hermaphroditic electrical connectors including:
a mating end that defines a first connector relief segment opposite a second connector relief segment and a first connector projection segment opposite a second connector projection segment,
at least one male contact extending from a face of the first connector relief segment and a single male contact extending from a face of the second connector relief segment,
at least one female contact formed in a face of the first connector projection segment and a single female contact formed in a face of the second connector projection segment;
wherein the first connector projection segment of a first hermaphroditic electrical connector in the pair couples into a respective first connector relief segment of a second hermaphroditic electrical connector in the pair such that the at least one female contact aligns with and receives the al least one male contact, and the second connector projection segment of the first hermaphroditic electrical connector couples into a respective second connector relief segment of the second hermaphroditic electrical connector such that the single female contact aligns with and receives the single male contact.

12. The backup power system of claim 11, wherein the network unit is an optical network unit and the backup power system is part of a telecommunications system.

13. The backup power system of claim 11, wherein the at least one pair of coupled hermaphroditic electrical connectors defines a power assembly, and the network unit electrically communicates with the battery backup unit via at least two power assemblies.

14. The backup power system of claim 11, wherein the first and second connector projection segments extend between the faces of the first and second connector relief segments.

15. The backup power system of claim 11, wherein each of the first and second connector projection segments define a first sidewall and a second sidewall, at least one of the first and second sidewalls including a friction latch.

16. The backup power system of claim 15, wherein the friction latch is an adjustable friction latch.

17. The backup power system of claim 11, wherein each female contact includes a stress relaxation restrictor sleeve disposed about a periphery of the contact.

18. A coupler coupled between a battery backup unit and a network unit, the coupler comprising:
a first hermaphroditic electrical connector;
a second hermaphroditic electrical connector; and
a plurality of electrical conductors coupling and extending between the first hermaphroditic electrical connector and the second hermaphroditic electrical connector, each hermaphroditic electrical connector including:
a mating end that defines a first connector relief segment opposite a second connector relief segment and a first connector projection segment opposite a second connector projection segment,
at least one male contact extending from a face of the first connector relief segment and a single male contact extending from a face of the second connector relief segment,
at least one female contact formed in a face of the first connector projection segment and a single female contact formed in a face of the second connector projection segment;
wherein the first hermaphroditic electrical connector is plugged into a corresponding hermaphroditic electrical connector that is electrically coupled to one of the battery backup unit and the network unit, and the second hermaphroditic electrical connector is plugged into a corresponding hermaphroditic electrical connector that is electrically coupled to an other of the battery backup unit and the network unit.

19. The coupler of claim 18, wherein the plurality of electrical conductors are maintained within a casing to define an electrical cord.

20. The coupler of claim 18, wherein the mating ends of the first hermaphroditic electrical connector and the second hermaphroditic electrical connector are substantially round and have substantially equal diameters.

21. The coupler of claim 18, wherein each of the first and second connector projection segments define a first sidewall and a second sidewall, at least one of the first and second sidewalls including a friction latch.

22. The coupler of claim 18, wherein each housing of the first hermaphroditic electrical connector and the second hermaphroditic electrical connector includes an over molded shell opposite the mating end.
